(19) United States
(12) Patent Application Publication
(10) Pub. No.: US 2005/0077700 A1
(43) Pub. Date: Apr. 14, 2005

(54) Modular wheelchair assembly

(76) Inventors: Mark E. Smith, Exeter, PA (US); John Wanberg, Apache Junction, AZ (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 10/957,232

(22) Filed: Oct. 1, 2004

Related U.S. Application Data
(60) Provisional application No. 60/509,493, filed on Oct. 8, 2003.

(51) Int. Cl. B62M 1/14

(52) U.S. Cl. 280/304.1

(57) ABSTRACT

A modular assembly for a manual wheelchair wheel is provided that includes first and second modules carrying front and back portions of a hand rail. The hand rail portions have surfaces adapted for a substantially abutting relationship when the modules are attached to each other. The assembly also includes third and fourth modules forming a wheel body and a wheel back portion. The wheel includes a central hub and spokes having separate portions carried by the third and fourth modules. The assembly may also include a cylindrical thumb rail portion having a surface adapted for a substantially abutting relationship with a surface of the hand rim when the modules are attached together. The hand rim is preferably contoured to provide a cross section that is substantially oval in configuration and may include indentations in the front portion to facilitate grasping engagement by a user.

### CROSS REFERENCE RELATED APPLICATION

This present application claims the benefit of the filing date of U.S. Provisional Patent Application No. 60/509,493, filed on Oct. 8, 2003.

### FIELD OF THE INVENTION

The present invention relates to wheel structure for wheelchairs or the like, and more particularly to a modular assembly for a manual wheelchair wheel including a hand rim for grasping engagement by a user of the assembly.

### BACKGROUND OF THE INVENTION

An occupant of a manual wheelchair provides propulsion for the wheelchair by drivingly engaging the rear wheels of the wheelchair. To facilitate the required engagement, known wheelchairs include hand rims secured to each of their rear wheels that are designed to be grasped by an occupant's hands. The hand rims of a manual wheelchair are supported outwardly from the rear wheels to place the hand rims in a location that is accessible to an occupant of the wheelchair.

A known manual wheelchair wheel assembly includes a tubular hand rim secured to a tire-supporting wheel rim by elongated supports at spaced locations about the hand rim. While such a construction locates the hand rim outwardly from the rear wheel as desired, the spacing between the supports exposes an occupant to potential hand injury through contact with, or impact by, one of the supports.

It is also known to secure a hand rim to the rear wheel of a manual wheelchair using a support member that extends continuously about the hand rim. The use of a single continuous support member serves to eliminate hand injuries that are associated with hand rims supported by multiple spaced supports.

### SUMMARY OF THE INVENTION

According to the present invention, there is provided a modular assembly for a manual wheelchair wheel. In a broad aspect, the modular assembly includes first and second modules adapted for attachment to each other at annular peripheral portions of the modules. At least a portion of the first and second modules form front and back portions of a hand rim for grasping engagement by a user. The hand rim portions include surfaces adapted for a substantially abutting relationship when the first and second modules are attached to each other.

According to a preferred embodiment of the invention, the hand rim is contoured such that the cross section of the hand rim is substantially oval in configuration.

According to one embodiment, the modular assembly also includes third and fourth modules having portions respectively forming a wheel body and a wheel back portion when the modules are attached together. Preferably, the third module includes a wheel rim adapted for receipt of a tire. The assembly may also include a cylindrical thumb rail having a surface adapted for a substantially abutting relationship with a surface of the front hand rail portion when the modules are attached together.

According to one embodiment, the wheel formed by the third and fourth modules includes a central hub and a plurality of spokes having opposite ends respectively connected to the hub and a wheel rim. The hub and the spokes include separate portions carried by the third and fourth modules.

The assembly may also include indentations in the front portion of the hand rim. The indentations serve to facilitate grasping engagement of the hand rim by a user of the assembly.

### BRIEF DESCRIPTION OF THE DRAWINGS

FIG. 1 is a side elevation view of a manual wheelchair including a rear wheel assembly according to the present invention.

FIG. 2 is a side elevation view of the wheel assembly of FIG. 1.

FIG. 3 is a section view taken along line 3-3 of FIG. 2.

FIGS. 3A and 3B are enlarged detail views taken from FIG. 3.

FIG. 4 is an exploded perspective view of the wheel assembly of FIGS. 1-3.

FIGS. 5-9 are sectional views respectively taken along lines 5-5 through 9-9 within FIG. 4.

FIG. 10 is a perspective view of a hand rim assembly according to a second embodiment of the invention.

FIG. 11 is a section view taken along line 11-11 of FIG. 10.

FIG. 12 is an exploded perspective view of the hand rim assembly of FIG. 10.

FIGS. 13 and 14 are section views respectively taken along the lines 13-13 and 14-14 of FIG. 12.

### DETAILED DESCRIPTION OF THE DRAWINGS

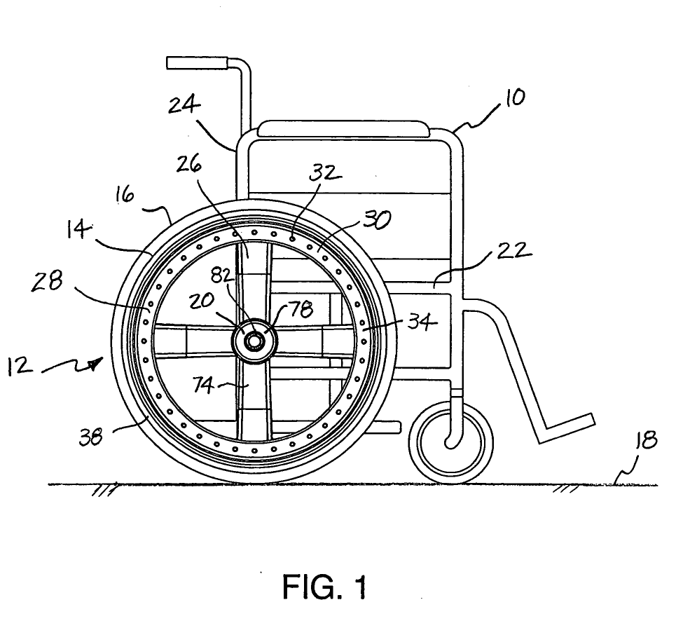

Referring to the drawings where like numerals identify like elements, there is illustrated in FIG. 1 a wheelchair 10 including a wheel assembly 12 according to the present invention. The right side of the wheelchair 10 is shown in FIG. 1, it being understood that an identical wheel assembly is provided on the opposite left side of the wheelchair 10, which is not shown. The wheel assembly 12 includes a wheel rim 14 adapted to receive a tire 16 to provide for rolling contact between the tires 16 and a support surface 18. The wheel assembly 12 also includes a central hub 20 adapted to provide for rotatable attachment of the wheel assemblies 12 to a frame 22 of the wheelchair 10. The wheel assembly 12 is attached to the frame 22 adjacent a rearward end 24 of the wheelchair 10 for propulsion of the wheelchair 10 by an occupant. The wheel assembly 12 also includes elongated spokes 26 having opposite ends respectively connected to the central hub 20 and the tire-receiving wheel rim 14.

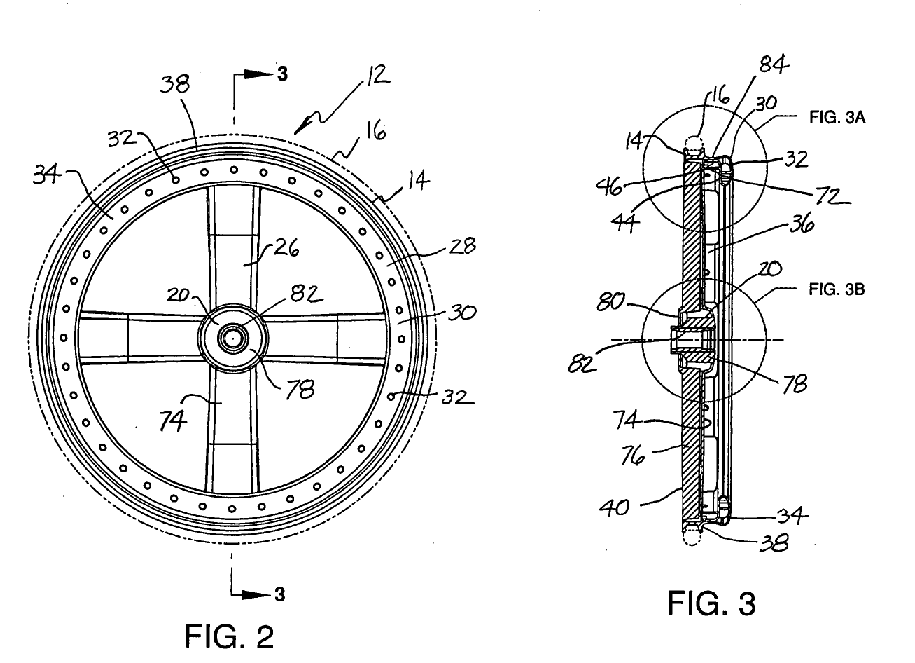

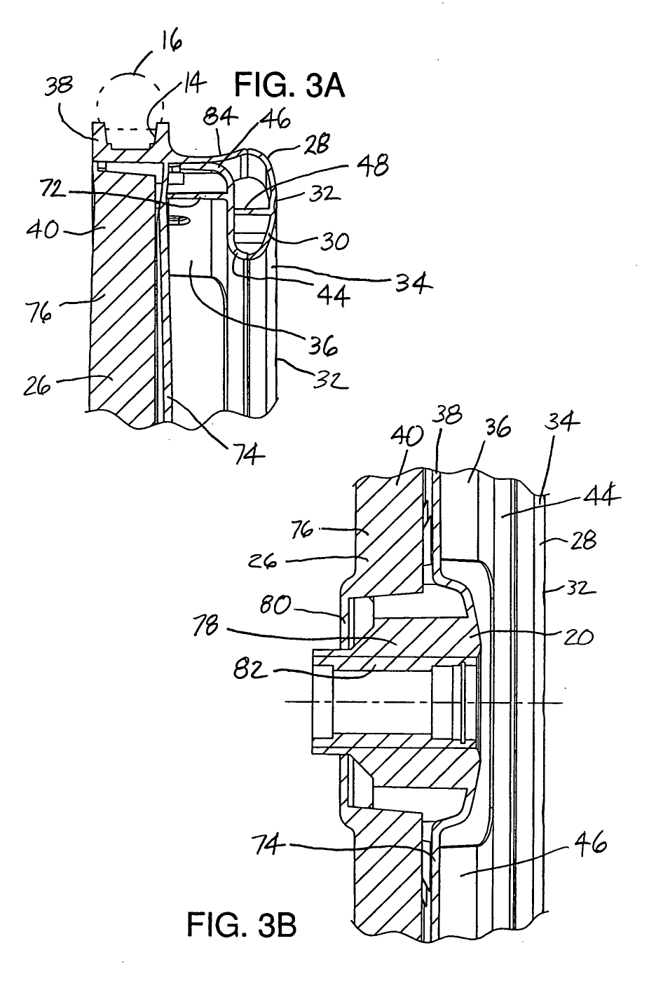

Referring to FIGS. 2 and 3, the wheelchair assembly 12 includes a hand rim 28 providing for driving engagement of the wheel chair 10 by a user. The hand rim 28 is secured to the wheel assembly 12 such that it will be located at a front, or outward, side. The outward location of the hand rim 28 on the wheel assembly 12 facilitates grasping engagement of the hand rim by a user.

Terms such as “outward”, “outer”, “forward” and “front” as used herein in regard to wheel assembly 12 should be understood to refer to the side of the wheel that is outward of or opposite the wheelchair structures when the wheel assembly 12 is attached to the wheelchair. Similarly, terms such as “inner”, “inward”, “back”, “rear” and “rearward” in regard to the wheel assembly 12 should be understood as referring to the hand rim side of the assembly 12. Terms such as “upper”, “lower”, “top”, “bottom”, “vertical” and “horizontal” as used herein in regard to the wheel assembly 12 should be understood to refer to the orientation of the wheel assembly 12 when attached to a manual wheelchair.

As shown in the enlarged detail view of FIG. 3B, the hand rim 28 of the present invention is contoured such that a front portion 30 of the hand rim 28 is elongated radially in a substantially oval, egg-shaped, manner. Contouring of the hand rim 28 in this manner provides for ergonomic engagement of the rim 28 by a user, thereby promoting greater efficiency in propulsion. As shown in FIGS. 2 and 3A, the hand rim 28 of the present invention also includes indentations 32 formed in the front portion 30. The indentations 32 are located intermediately on the front portion 30 of hand rim 28 and are preferably evenly spaced about the circumference of the rim. The indentations 32 create localized variations in the surface of the front portion 30 that promotes engagement by a user's hand.

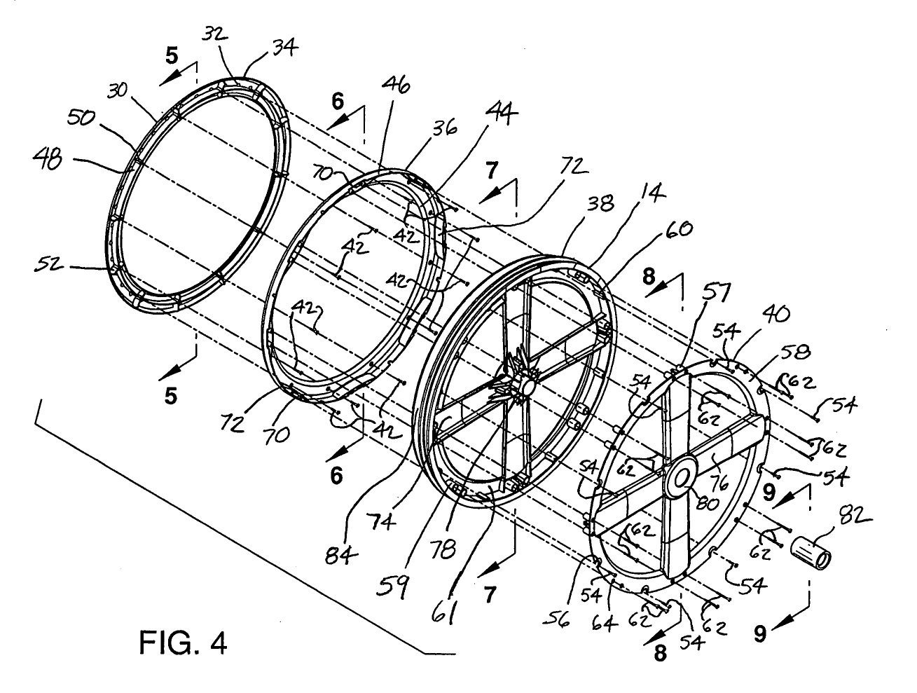

As shown in the exploded perspective view of FIG. 4, the wheel assembly 12 is modular in construction and is formed in four parts 34, 36, 38, 40 that are fastened together at outer annular portions thereof. The modular construction of the present invention facilitates formation of the wheel assembly from injection molded materials. A suitable material for forming the modular parts of the wheel assembly 12 is nylon although other injection moldable materials could conceivably be used as well. The present invention, however, is not limited to injection molding or injection moldable materials.

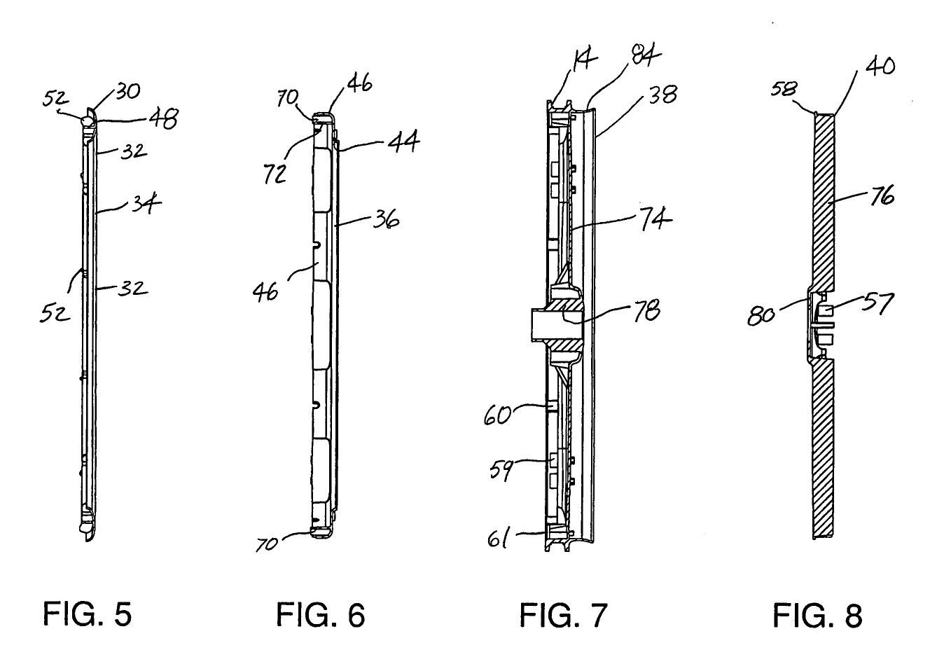

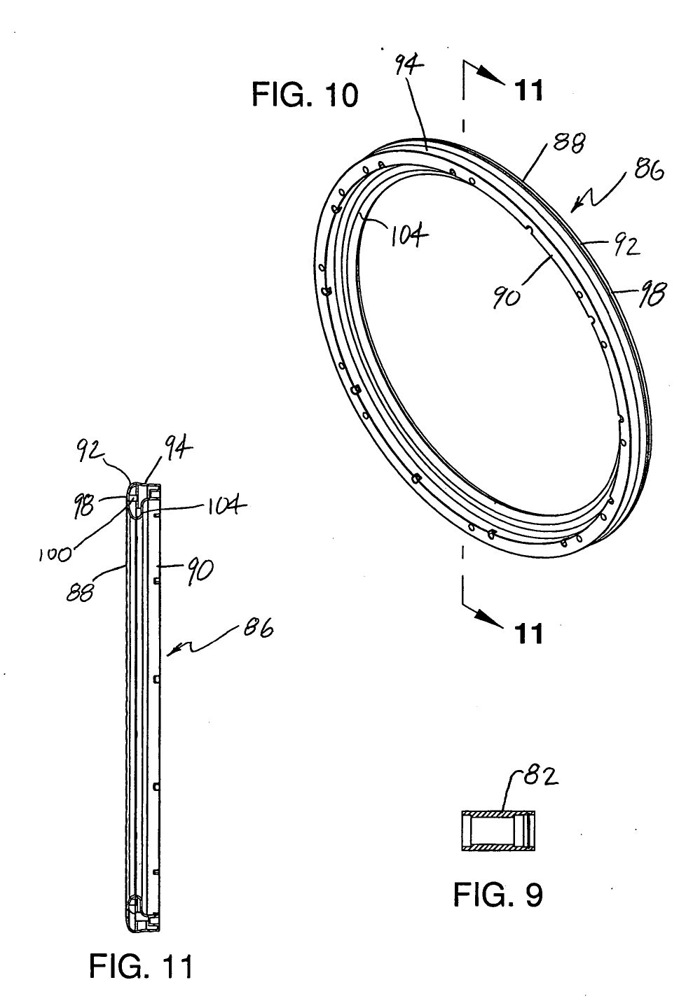

The first module 34 of the wheel assembly 12, which is shown in cross section in FIG. 5, includes the front portion 30 of the hand rim 28. The first module 34 is secured to the second module 36, shown in cross section in FIG. 6, by screws 42 at twelve locations (as shown) spaced about the first and second modules 34, 36. The second module 36 includes certain portions 44, 46 that are oppositely directed from each other, such that they define a substantially serpentine cross section (as shown in FIG. 3A). One portion 44 is outwardly directed with respect to the wheelchair 10 such that it confronts the front hand rim portion 30 at one end in a substantially abutting relationship to form the back of the hand rim 28. The other portion 46 defines a substantially cylindrical stand-off that serves to locate the hand rim 28 at a distance from the wheel rim 14, which is carried by the third module 38.

As discussed above, the outward location of the hand rim 28 from the wheel rim 14 facilitates grasping of the hand rim by a user. The screws 42 are received through holes in the hand rim back portion 44 on the second module 36 and engage a cylindrical ring 48 on the first module 34. The ring 48 includes enlarged portions 50-to accommodate the screws 42. The first module 34 also includes wing-like projections 52 adjacent the enlarged ring portions 50 and oriented substantially perpendicular to the ring 48. As seen in FIG. 3A, the perpendicular projections 52, in combination with the ring 48, serve to limit distortion or collapse of the hand rim 28 thereby maintaining the hand rim in the desired contoured shape.

The third and fourth modules 38, 40, shown in cross section in FIGS. 7 and 8, respectively define a wheel body and a wheel back. The wheel body 38 and wheel back 40 are secured together by screws 54 at eight locations (as illustrated) and form the tire-receiving portion of the assembly 12. The screws 54 are received in notches 56 in an annular portion 58 of the fourth module 40 and engage enlarged portions 60 on the rim 14 that are defined by the third module 38. As shown in FIG. 4, the fourth module 40 includes hollow cylinder posts 57 connected to the annular portion 58. The posts 57 are received in hollow cylinder receptacles 59 secured to an annular portion 61 of the third module 38, opposite the annular portion 58.

The hand rim 28, which is formed by the first and second modules 34, 36, is secured to the wheel, which in turn is formed by the third and fourth modules 38, 40, by pairs of screws 62 at eight locations (as illustrated) about the modules. The screws 62 are received in openings 64 in the annular portion 58 of the fourth module 40. The openings 64 are aligned with the hollow cylinder posts 57 such that the screws extend through the posts 57 and the receptacles 59 of the third module 38. The screws 62 extend from the posts 57 of the third module 38 to engage cylinder posts 70 carried by the second module 36. The screw-engagement posts 70 are secured to pocket walls 72 defined on an inner surface of the second module standoff 46.

As discussed above, each of the spokes 26 of the wheel assembly 12 are divided and include portions 74, 76 respectively carried by the third and fourth modules 38, 40. The hub 20 is also divided and includes portions 78, 80 respectively carried by the third and fourth modules 38, 40. The spoke portions 74 of the third module 38 extend between the hub portion 78, which forms the majority of the hub 20, and the rim 14. The spoke portions 76 of the fourth module 40, each forming the majority of one of the spokes 26, extend between the hub portion 80 and the annular portion 58 of the fourth module 40.

The wheel assembly 12 also includes a hub insert 82, which is preferably made from aluminum. As best seen in FIG. 3B, the hub insert 82 is received by the hub 20 to facilitate the rotatable attachment between the wheel assembly 12 and a wheelchair, such as the manual wheelchair of FIG. 1 for example.

As shown in FIG. 3A, the third module 38 includes a substantially cylindrical rail portion 84, which is connected to the rim 14. The rail portion 84 confronts the hand rim front portion 30 at one end thereof in a substantially abutting relationship. The rail 84 defines a surface for resting contact by the thumb of a user when the user's hand is engaging the hand rim 28.

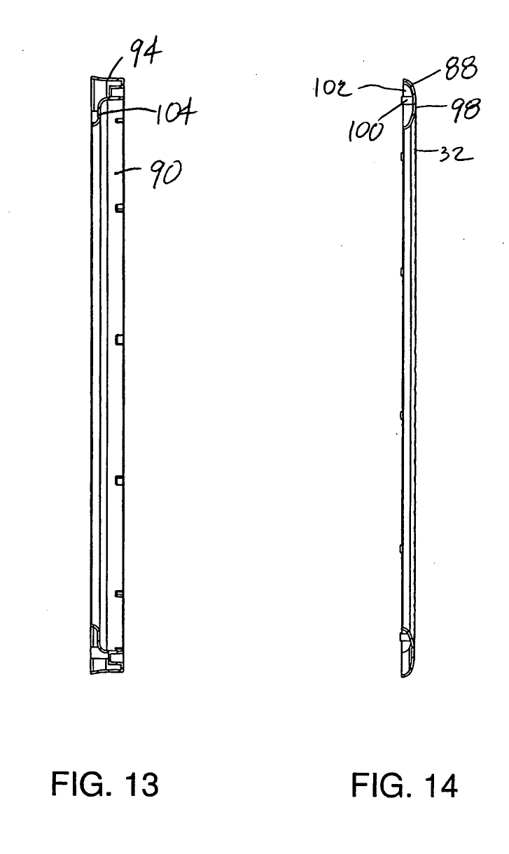

Referring to FIGS. 10-14, there is shown a modular hand rim assembly 86 according to the present invention attachable to the wheel of a manual wheelchair. The hand rim assembly 86 includes first and second modules 88, 90 respectively shown in cross-section in FIGS. 14 and 13. As shown in FIGS. 10 and 11, the hand rim assembly 86 includes a hand rim 92 and a thumb rail 94 for engagement by a user's hand.

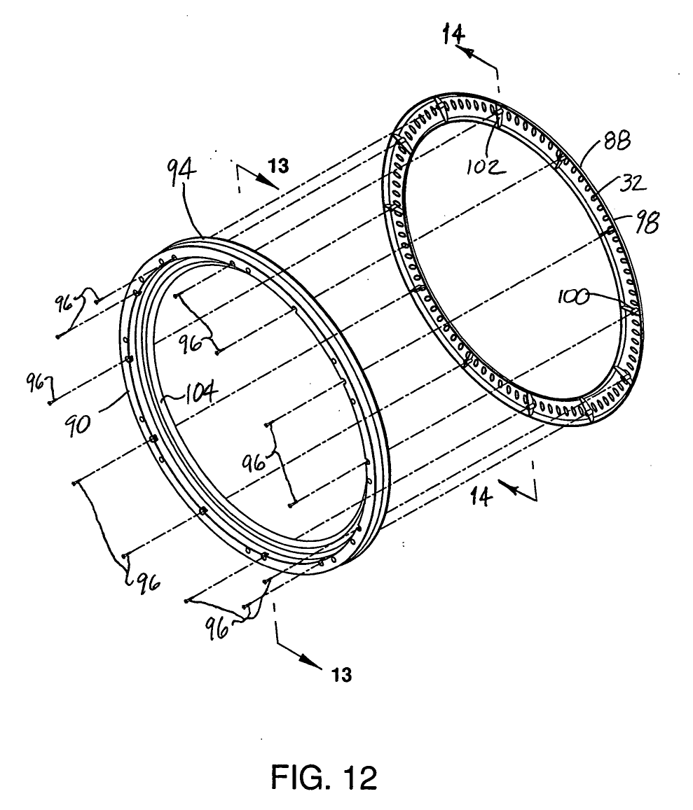

Referring to the exploded perspective view of FIG. 12, the first and second modules 88, 90 are secured to each other by screws 96 at twelve locations (as illustrated). The first module 88, in a similar manner as the first module 34 of wheel assembly 12, defines a front portion 98 of the hand rim 92. The first module also includes cylinder posts 100 engaged by screws 96 and projections 102 for maintaining the contoured shape of the hand rim 92. The first module 88, however, does not include a ring like the ring 48 of wheel assembly 12.

The second module 90 of hand rim assembly 86, in a similar manner as the second module 36 of wheel assembly 12, includes a portion 104 confronting the hand rim front portion 98 at an end thereof in a substantially abutting relationship to form the back of the hand rim 92. The second module 90, however, differs from the second module 36 of wheel assembly 12 by including the thumb rail 94, which is defined by a cylindrical portion of the second module 90. As discussed above, the cylindrical rail 84 of the wheel body of wheel assembly 12 (i.e., the third module 38) forms the thumb rest.

The wheelchair shown in FIG. 1 should be understood as representing manual wheelchairs in general. The present invention is not limited to the particular wheelchair shown and may be adapted for use with other manual wheelchairs of varying construction.

The foregoing describes the invention in terms of embodiments foreseen by the inventor for which an enabling description was available, notwithstanding that insubstantial modifications of the invention, not presently foreseen, may nonetheless represent equivalents thereto.

1. A wheel assembly comprising:
a wheel including a wheel rim adapted for receipt of a tire; and
a hand rim spaced from the wheel to provide for grasping engagement by a user, the hand rim comprising separate front and back portions respectively carried by first and second members secured together, the front and back portions having adjacent surfaces arranged in a substantially abutting relationship.

2. The wheel assembly according to claim 1, wherein the hand rim has a cross section that is non-circular.

3. The wheel assembly according to claim 2, wherein the hand rim cross section has a substantially oval configuration.

4. The wheel assembly according to claim 1, wherein the first and second members are secured together by fasteners.

5. The wheel assembly according to claim 1, wherein the front portion of the hand rim includes a plurality of indentations spaced about the hand rim to facilitate engagement between the hand rim and a user's hand.

6. The wheel assembly according to claim 4, wherein the first member includes a ring secured to the hand rim first portion, the ring having enlarged portions each adapted for engagement by one of the fasteners, and wherein each fastener is received through a hole in the second member and engages one of the enlarged portions of the ring of the first member.

7. The wheel assembly according to claim 2, wherein the first member further includes projections oriented substantially perpendicular to the ring at spaced locations about the ring.

8. The wheel assembly according to claim 1, wherein the wheel includes a central hub and a plurality of elongated spokes having opposite ends respectively connected to the hub and the rim, and wherein the hub and each spoke comprise separate portions carried by the third and fourth members respectively.

9. The wheel assembly according to claim 8, wherein the fourth member includes cylindrical posts received by hollow cylindrical receptacles of the third member.

10. The wheel assembly according to claim 9, wherein the wheel and the hand rim are secured together by threaded fasteners received in openings in the fourth member and extending through the posts on the fourth member to engage posts secured to the second member.

11. The wheel assembly according to claim 1, wherein the second member includes a stand-off portion oppositely directed from the hand rim back portion, the stand-off portion serving to maintain the hand rim in a spaced relationship with respect to the wheel.

12. The wheel assembly according to claim 10, wherein the second member includes a ring portion at an outer periphery thereof and pocket walls secured to the ring portion at spaced locations about the second member to define pocket spaces between the pocket walls and a surface of the ring portion, and wherein the fastener-engaged posts of the second member are located within the pocket spaces and secured to the pocket walls.

13. A modular wheel assembly for a manual wheelchair, the modular wheel assembly comprising:
first, second, third and fourth modules adapted for attachment at annular peripheral portions thereof,
at least a portion of the first and second modules forming front and back portions of a hand rim for grasping engagement by a user, the front and back portions of the hand rim having surfaces adapted for a substantially abutting relationship when the modules of the assembly are attached together,
at least a portion of the third and fourth modules respectively forming wheel body and wheel back portions of a wheel when the modules of the assembly are attached together, the wheel body portion including a wheel rim adapted for receipt of a tire.

14. The modular wheel assembly according to claim 13, wherein the wheel assembly includes a center hub and wherein portions of the third and fourth modules respectively form spoke portions of a plurality of elongated spokes when the modules of the wheel assembly are attached together, the elongated spokes having opposite ends connected respectively to the center hub and the wheel rim.

15. The modular wheel assembly according to claim 14, wherein portions of the third and fourth modules carry hub portions that form the center hub when the modules are attached together.

16. The modular wheel assembly according to claim 13, wherein the third and fourth modules respectively include hollow cylindrical receptacles and cylindrical posts connected to the annular peripheral portions thereof, and wherein the posts of the fourth module are adapted for receipt within the receptacles of the third module when the modules of the wheel assembly are attached together.

17. The modular wheel assembly according to claim 13, wherein the third module includes a substantially cylindrical portion connected to the wheel rim and forming a thumb rail for resting receipt of a user's thumb, the thumb rail portion of the third module having a surface adapted for a substantially abutting relationship with a surface of the front hand rim portion when the modules are attached together.

18. A modular assembly for a manual wheelchair wheel, the modular assembly comprising:
first and second modules adapted for attachment to each other at annular peripheral portions of the modules,
at least a portion of the first and second modules respectively forming front and back portions of a hand rim for grasping engagement by a user, the front and back portions of the hand rim having surfaces adapted for a substantially abutting relationship when the first and second modules are attached together.

19. The modular assembly according to claim 18, wherein the second module includes a substantially cylindrical portion forming a thumb rail for resting receipt of a user's thumb, the thumb rail portion of the second modules having a surface adapted for a substantially abutting relationship with a surface of the front hand rim portion when the modules are attached together.

20. The modular assembly according to claim 18 wherein the hand rim formed when the first and second modules are attached to each other is contoured such that the cross section of the hand rim is substantially oval in configuration.
